(19) United States
(12) Patent Application Publication
(10) Pub. No.: US 2014/0297001 A1
(43) Pub. Date: Oct. 2, 2014

(54) SYSTEM AND METHOD FOR ADAPTIVE AUTOMATED RESOURCE MANAGEMENT AND CONSERVATION

(71) Applicant: Lawrence Silverman, Newtown Square, PA (US)

(72) Inventor: Lawrence Silverman, Newtown Square, PA (US)

(73) Assignee: KASPAR LLC, Newtown Square, PA (US)

(21) Appl. No.: 13/853,033

(22) Filed: Mar. 28, 2013

(51) Int. Cl. G05B 13/02

(52) U.S. Cl. CPC G05B 13/02
USPC 700/19

(57) ABSTRACT

Systems, methods, and devices to provide simple adaptive automated resource management of a resource system (such as but not limited to electricity, natural gas, water, data, bandwidth allocation, access to information, etc.) on a local basis, based on automatically detecting, measuring and combining time-varying resource provider preferences, resource market conditions, resource supply source conditions, environmental conditions and resource system impact on the environment, together with resource user locations, user priorities and preferences, and information about other conditions that may be relevant to the operation of the resource management system in order to optimize performance of the resource system to better meet or approach defined goals, and to measure and display the results achieved by the resource management system compared against those goals.

### TECHNICAL FIELD

This invention relates to automating the control and management of consumable resources, such as electricity, natural gas and water, access (physical and digital) and in particular to such resource control and management systems that can detect the presence of one or more users, identify a user, and implement control algorithms for managing the operation of various resources in accordance with a stored profile of responses based on that user's identity, that user's priority with respect to other users, the user's location, and, if the user is moving, the direction, speed and probable destination of the user, as well as in accordance with the state of the relevant resources being managed and other data acquired by the resource management system as further described herein.

### BACKGROUND OF THE INVENTION

One of the major problems in managing the use and consumption of resources, such as the use of electricity by heating, ventilation and air-conditioning (“HVAC”) equipment, electric space heating or water heating, appliances, lighting or other building equipment, and access to computer data, is determining the schedule and preferences of persons occupying a specific area of a facility in order to program local operating procedures into devices such as programmable thermostats, so that they implement operation upon the arrival of an occupant, or at an earlier time in preparation for that occupant's arrival. For example, despite the fact that some of the largest potential savings in electricity consumption can be achieved by the use of programmable thermostats and lighting controls, the complexity and difficulty of predicting and programming occupancy schedules and individual preferences for temperature and light levels have resulted in extremely low rates of actual user-programmed operation of these devices even where they have been installed. A number of factors contribute to the low rate of user-programmed operation of programmable thermostats: the complexity of programming the devices, small screen sizes that are difficult to read, inconvenient locations for users to work in, differences in user-interface design between different manufacturers, and further, variations between temperature preferences between various users, the difficulty of predicting in advance who will occupy a given space and when, and changes in established patterns of use. As a result of the low rate of user programming, the savings realized by existing programmable thermostats and similar occupancy and schedule-based devices is substantially less than that which could be achieved by a more adaptive and automated system that did not require user predictive programming, repeated intervention or supervision.

One approach currently employed is to utilize conventional occupancy sensors (PIR or similar), that can in turn be linked to thermostats or lighting controls. However, these existing occupancy-sensor-based systems have limitations in distance and sensitivity, and can turn off devices when they fail to detect continued occupant activity, forcing users to change their locations or wave their arms to reactivate the system. In addition, they do not accommodate the individual needs or preferences of specific users, nor are they able to determine the number of occupants or other characteristics or needs of particular individual occupants in a given area who may have special requirements that must be met in order to optimize the operation of various equipment for their specific needs or preferences. A final problem is that conventional thermostats measure temperature at their own location, which can be relatively far from the location of the user, so that the there can be significant variation between the temperature reading at the thermostat and that at the user's actual location. All of these factors result in inefficiencies due to the inability of these control systems to specifically adapt and optimize performance in response to the particular preferences, location and other characteristics associated with a given user of group of users.

More sophisticated systems accumulate time-stamped data from occupancy sensors, user manual set-point adjustments and historical data on conditions such as inside temperature, outside temperature, humidity and barometric readings. This data is correlated and used to “learn” the patterns of occupancy in a room and establish an occupancy schedule and temperature set-points for that space. However, this method fails to accommodate multiple and differing user preferences, special needs, exceptional situations, or changes in user schedule. At best this approach is effective for a space where occupancy is fairly rigidly scheduled and used by the same set of occupants with established shared preferences.

In actual practice, as people have generally become increasingly mobile, many users no longer maintain fixed, predictable schedules. Their location and schedule can be subject to unanticipated changes and exceptional events. In addition individual users have differing preferences for suitable temperature and lighting levels and other conditions that are produced by the operation of the systems being managed; these user preferences include such factors such as the user's age, health, physical condition, present activity, etc., and can also vary by time of day. Finally, within a given group of users, the preferences of one or more identified user(s) may have priority over those of other users (for example, one user may have priority because she is an 80-year old grandmother who may require a higher level of lighting in order to see properly). Thus, in order to fully optimize the operation of a given system to meet the needs of a specific group of users, an approach is needed that does not require the users themselves to accurately predict their schedules and locations, and also allows for implementing the specific preferences of users, implements priorities between the various users, resolves possible conflicts or differences between the preferences of the various users, and can learn and continually adapt to the changing use patterns of users within a given area.

### SUMMARY OF THE INVENTION

The subject invention provides a solution to this problem through the combination of user presence detection using sensors and communications technology (such as but not limited to near field detection), to identify and implement a variety of responses, including pre-selected preferences specific to that user, in order to automatically manage operation of resource devices, controls and systems, thus eliminating the need for users to attempt to accurately predict their patterns of use or to program devices and systems accordingly. In one embodiment of the subject invention, as demonstrated in the attached drawings and specification, the detection and identification information can be received through a near field communication interface on an electronic user interface device such as a portable cell phone, tablet, smart watch or other electronic user interface device or from a wireless radio frequency identification (RFID) tag associated with an electronic user interface device.

As one example, the subject invention includes a method for using at least one instance from a variety or combination of active and/or passive electronic presence detection devices and other sensors to detect and attempt to identify a user or multiple users, in order to access user profiles that include a set of user preferences and priorities established by or for specific individual users, or for classes of users, with respect to the operating goals of the resource management system. This detection and identification process can be conducted on a local CPU (for example using a CPU and software contained in an electronic user interface device such as a thermostat, or a lighting control or other environmental control), or on a remote CPU associated with the system. The results of the detection and identification process provide a basis for response by the system. The response of the system is managed by instructions from one or more local or remote CPUs by the operation of a set of algorithms that analyze data from various sources (the “Decision Engine”).

The response of the Decision Engine will vary depending on whether the user is identified or not, and on stored user preferences if they are identified. The detection and any associated information will be used to determine the response of the resource management system, using the adaptive automation rules and algorithms in the Decision Engine to determine and issue instructions to devices and controls within the system.

On one hand, if the user is identified, the system can reference a look-up table of the preferences and priorities established for that identified user and respond according. On the other hand, if the user is not able to be identified, the system can trigger a different response, such as a challenge, alarm notification, activate a camera, etc. The detection and any associated identification information can optionally be shared with other selected devices outside of the resource management system to implement additional operations not directly associated with the resource management system, such as preferences for choices such as dimmed levels of lighting, music, video or other systems. There are a number of other commonly-installed systems that do not involve consumable resources but that can be provided with enhanced functionality through an interface with the Decision Engine. For example, an interface with a conventional security monitoring or intrusion alarm system is contemplated to provide security personnel back-up in the event of an unidentified occupant or user emergency. In addition, an interface with a mobile communications system, such as automobile-based ONSTAR, may be included so a user can access and provide inputs to the system remotely from their mobile device. If multiple users are identified in an area, the Decision Engine can mediate any potential conflicts between their respective preferences, including their possible “priority” within the system.

A further feature of the subject invention is the use of two or more user presence detection devices, separated by a distance, to determine the direction, size and speed of movement of an occupant. This is accomplished by detecting an occupant at one of a series of two or more sensors, and then detection at the next in the series, the order of detection indicating the direction of movement of the occupant. Likewise, the time between detection relative to the distance separating the detectors can be used to calculate the speed of movement of the occupant. If the sensors have a different vertical orientation, they can also measure the size or height of an occupant. This information can be employed to prepare conditions according to user preferences and priorities in areas or locations they have not yet entered but may be approaching. In addition, knowing the direction of movement of a user enables the system to determine whether they are entering or leaving an area.

Preferences can include a time delay so that a given set of conditions are maintained for a period of time after the user leaves the area. Furthermore, the ability to track entries and exits permits the system to calculate the number of users, whether identified or not, that remain in an area, and to adjust and re-optimize resource management accordingly.

This information can be further compared with a history of previous movements and destinations of the specific occupants at similar times and under similar conditions, to predict the probability of a specific location being the intended destination of the user at that time under that set of conditions. By accumulating historical information on the location and identities of specific users at particular times and under specific conditions as recorded by sensors, the system “learns” the probable behavior of its users. For example, if user A moves between location sensor 1 and location sensor 2 and 90% of the time between 8 am and 9 am ends up in location 3, then the system can prepare location 3 in advance of user A's arrival, but is able to maintain a lower (more energy conservative) level of performance at other times. In another example, where the probability of user arrival (“PUA”) in location 3 is only 50% based on historical data, then if the user has chosen a preference for a greater degree of conservation, the preparations may not be implemented until the user actually arrives in location 3, whereas a preference for a higher level of comfort or lower level of conservation can cause the Decision Engine to implement the preparations earlier despite the lower PUA. These trade-offs can be programmed into the underlying software algorithms in the Decision Engine to determine a desired outcome based on the combination of user preferences and other parameters.

The degree of “Conservation” implemented by the system can also be managed as a function of the PUA. In a system set for a high degree of Conservation might implement energy-using anticipatory comfort preparations for a user's arrival with a PUA of 80%, whereas the same system set to a lower level of conservation might implement them with a PUA of only 40%.

Finally, one of the electronic user interface devices contemplated in this invention that may incorporate near field communications is a cell phone. A further method of operation includes enabling a user to send a message from the cell phone in advance of their arrival at a managed location, so that their preferences can be implemented in advance. This can be especially useful if the resource concerned is electricity, and the actual occupancy will take place during a period of peak electricity use. In this event, the Decision Engine can implement a pre-cooling algorithm so that the area is cooled prior to the user's arrival, when electricity may be less expensive, and simply cycled during the period of occupancy to maintain acceptable comfort levels at reduced cost.

Whereas the goal of many applications of NFC communications is to establish machine-to-machine interoperation, using a single protocol common to all devices within an area, the present invention seeks to use NFC and other communications to interoperate across a range of disparate devices, some using varying protocols, to interact in different ways with specific different users or classes of users, and in a time-varying manner, in order to automatically achieve or approach a set of goals or objectives established in advance for a resource management system. These goals can also include interoperation with other systems, such as security/intrusion detection and entertainment systems. However, the primary objective of the present invention is to manage and optimize the delivery, local generation, transformation, storage and use of consumable resources such as energy, water, bandwidth and other critical resources utilized in maintaining the ongoing functions of structures in the built environment.

An additional feature of the subject invention is the capability to embed a temperature sensor into a user's electronic user interface device at the user's location that will communicate this information to a remote temperature control or thermostat, so that adjustment of thermostat will be in response not only to the user's identity and preferences, but also to the temperature at the actual location of the user. Similar strategies for lighting can be implemented using light sensors in combination with lighting controls, as well as other environmental sensors.

In the case of a thermostat, if the user's electronic user interface device includes a screen and communications with a wall-mounted control for HVAC, the wall-mounted control (ref. FIG. 57) can be reduced to a set of relay switches that operate the compressor and fans for the HVAC system recessed into the wall behind a flat plate (that can be painted over), so that the user's electronic user interface device provides information about present temperature at the user's location and desired set-point, then sends that information to the relay control unit that actually operates the HVAC. Separating the temperature-sensor and user-interface from the control switches and relays allows the latter to be located anywhere—remotely or at the compressor unit itself, so long as there is a communications link between the control switches and relays and the compressor unit inputs. Communicating temperature sensors can be placed in a user's electronic user interface device, at an in-wall control box, and/or in other locations. A further implementation is contemplated in which the user's electronic user interface device is operated by a rechargeable battery and can be mounted through the use of a magnet or other temporary mounting method to the plate covering the in-wall control box. The in-wall control box can also further contain an inductive charging circuit to recharge the battery in the user's electronic user interface device through the wall plate.

The subject invention provides a simplified method to optimize overall resource system performance with respect to resource supply, demand and environmental impacts with respect to user preferences and occupancy. The resource management system includes a Decision Engine that uses data gathered from devices and sensors in the resource network, including resource delivery, storage, generation and consumption devices as well as sensors that provide information about resource parameters that may be relevant to management of the resource (such as those related to the supply, delivery, storage, consumption of the resource), along with other parameters such as environmental conditions and the environmental impact of the operation of the resource system itself. The Decision Engine in the resource management system implements a set of goal-oriented adaptive automation rules or algorithms that are designed to manage the overall system on a time-varying basis, in order to achieve or more closely approach the established resource system management goals under a particular set of conditions.

The Decision Engine utilizes present data about resource system parameters, and also references a database of historical data. That data is analyzed in order to assess trends and predict future outcomes, enabling the system to further optimize resource consumption on a predictive and proactive basis. The resource management system Decision Engine analyzes the collective data and applies the adaptive automation algorithms, and then issues instructions that are dispatched to communicating device controls within the system to modify the operation of these devices. The resource management system employs frequent feedback in an iterative manner, repeatedly measuring the outcomes resulting from any change in the system, and feeding that data back to the Decision Engine to analyze the impacts of the change, so that the Decision Engine can then issue an updated set of instructions in response.

The adaptive automated resource management system and Decision Engine can be contained in one or more computers (CPUs), and may also include related application servers and database servers. These may be located in the resource end-use location, on a location in the resource supply system, remotely (such as in a cloud-based system), or using combinations of these and other local and/or distributed computing and sensing/control resources, including portable electronic user interface devices such as cell phones, internet-enabled tablets, small portable displays and handheld remote controls. Additionally, for security and/or privacy purposes, resource and application data may be isolated at, or restricted to, certain locations, specific users or some users may be provided with limited restricted access. Multiple networks can be integrated into a single system, and communications are not limited to a single communications medium or protocol, so that the various elements of an overall system can communicate through a variety of means, including but not limited to, the Internet, telephone and cellular networks, satellite, power line, IRDA, Ultrasonic and various other wired (incl. powerline) and wireless media and networks, and segmented into wide-area networks (WAN), community-area networks (CAN), local area networks (LAN) and personal area networks (PAN) or other existing or ad hoc networks.

In particular, the subject invention enables the adaptive automated resource management system to be operated in a simplified manner by an unskilled user through the integration of near field communications (NFC) devices with other wired and wireless communicating devices, sensors and networks as described herein.

In a sample implementation that is described in detail further herein, user preferences can be recorded and stored either (1) only on a local computer CPU (implementing privacy control), and/or (2) on a remote computer. Additionally, the local computer can be instructed to use generic data only in communications with a remote computer in order to further protect privacy for users.

A user can access their system remotely from diverse electronic user interface devices for network connectivity, such as cellphones, ONSTAR and similar mobile vehicle networks, internet-connected touchscreen displays (e.g. the iPad from Apple Corp.) or similar devices.

After a user has been identified and authenticated, their preferences are looked-up in the database and communicated to the Decision Engine. These user preferences are then added to other data in the database and operating instructions sent to the electrical control devices. Multiple sensors can track user movements in a facility and establish repetitive patterns in order to implement scheduled operations insofar as regular, repetitive patterns may be established (e.g. a “learning” mode).

Privacy parameters are as follows:
(1) broadcast preferences can be received by any device set to “Open Access” so that it will accommodate any user; a privacy gate can be invoked as an option by an authorized manager in the local CPU.
(2) Privacy request can be included in an application on a portable electronic user interface device subject to approval from local CPU with optional return notification.
(3) If no ID of the user is determined, an attempt by that unidentified user to control any network device on the system can trigger an alarm signal.
   These and other parameters are discussed further in the detailed description below.

### BRIEF DESCRIPTION OF THE DRAWING

Figure A-1 is a basic block diagram of the preferred embodiment of the present invention.

Figure A-2 is a flowchart of the basic operation of the present invention.

### DETAILED DESCRIPTION OF THE PREFERRED EMBODIMENT

One or more specific embodiments of the present invention are described below. In an effort to provide a concise description of these embodiments, not all features of an actual implementation are described in the specification. It should be appreciated that in the development of any such actual implementation, as in any engineering or design project, numerous implementation-specific decisions will be made to achieve the developers' specific goals, such as compliance with system-related and business-related constraints, which can vary from one implementation to another. Moreover, it should be appreciated that such a development effort might be complex and time consuming, but would nevertheless be a routine undertaking of design, fabrication, and manufacture for those of ordinary skill having the benefit of this disclosure.

### DEFINITIONS

The following definitions are used in the detailed description of the invention:

Sensor—Sensors include (but are not limited to) meters to measure and report resource parameters, occupancy sensors (active and passive), time clocks, emissions detectors (for example sensors to detect explosives, gases, particulates, ozone indicating short circuits, etc.), temperature, humidity, wind speed. All sensors in the invention are able to communicate their data back to a remote transceiver.

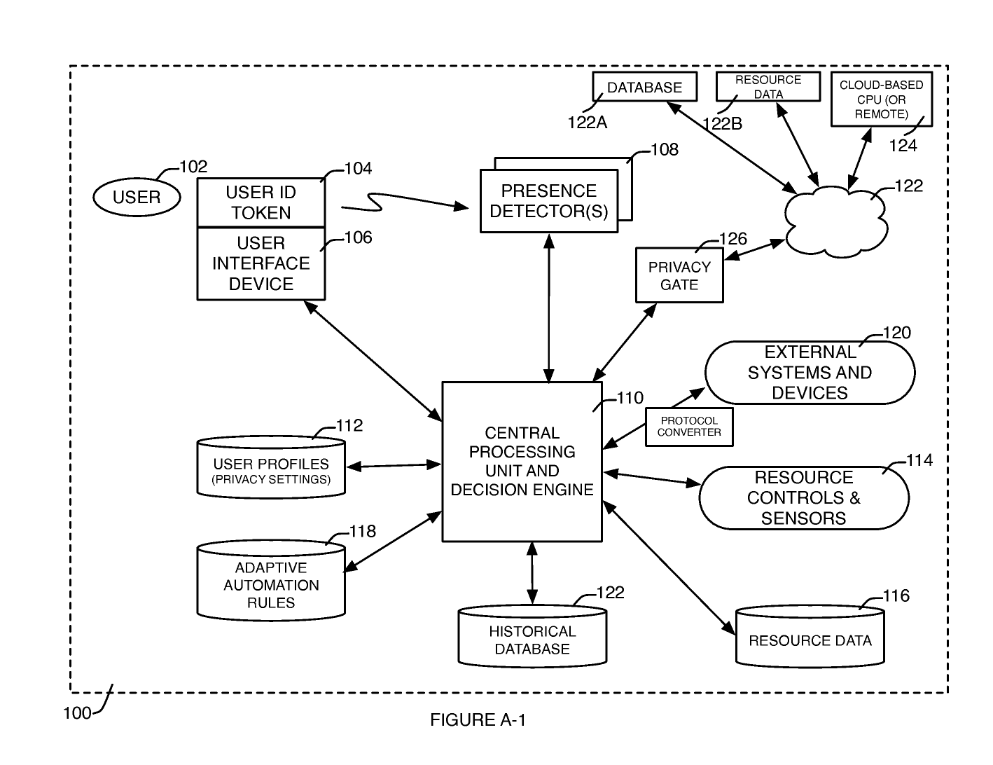

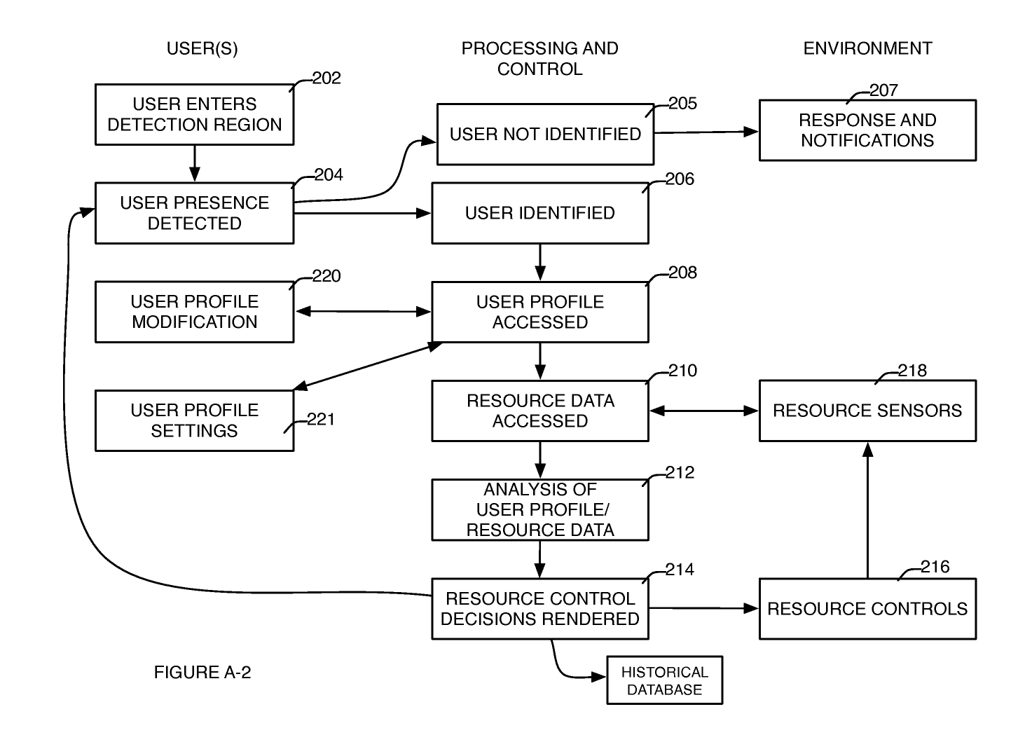

Decision Engine—All of the computing and data collection and storage resources, whether co-located or physically distributed, that interoperate to make decisions on the operations of the energy management system are referred to as the “Decision Engine”. Decisions are made based on applying a set of rules and algorithms that operate on data collected from a variety of sources. The Decision Engine will analyze the potential outcome from different operating procedures and select that one which produces the greatest “value” according to the rules established. When a user is a member of such a conservation incentive program and the Decision Engine is used to evaluate the impact of the operation of the system in order to dispense incentive “points” to the user, it may also be referred to as a “Points Engine” (ref. FIGS. 2, 4 and 5). Thus, when the system operates in a manner that conserves electricity for the user, they can view their savings as it accumulates, and also the quantity of incentives they earn if they are members of such a program (ref. FIG. 11).

Manager [symbol] the primary system manager is responsible for system setup, assigns priorities, and/or is able to modify the operation of the Decision Engine; a system can have multiple sub-managers with their own different levels of priority that provide access to specific sets of functionality and control. Sub-manager priorities are established by the primary system Manager.

Priority [symbol] system users can be assigned different user priorities; conflicts will be resolved by a set of algorithms in the Decision Engine that may be modified by a system manager.

Near Field Device [symbol] a device that sends and/or receives communications signals using a variety of near-field communications media, including (but not limited to) RF, bluetooth, zigbee, and local Wi-Fi. Near field devices may be both passive and/or active. Their locations can be fixed or mobile.

CPU (Central Processing Unit) [symbol] any microprocessor that may interface with supplementary memory, database, algorithms and communications capabilities and is used to provide operational and/or Decision Engine capabilities for the system.

Cloud-Based System [symbol] remote communicating CPU that is linked to a local system by an Internet, transported over a wired or wireless medium (e.g. cellular, satellite, wireless broadband) or similar connection

Preferences of an Identified Occupant [symbol] ID Preferences are a set of goals specific to identified users that can include but are not limited to preferred temperature range, air movement, humidity, level of conservation, budget, seasonal and time-of-day variations, response based on utility prices, type of utility supply, age, activity, number of other occupants, user priority, priority modification for other specific users (e.g. an elderly relative's preferences may be given priority if she is in the room), learned responses (e.g. if user passes sensor A then sensor B between 8 am and 11 am, the probable destination based on past behavioral data, with a probability of X %, is area C) and other information, either entered by the user, manager or repeated behavior learned by system, specific to an individual or group of individuals. Systems managing resources such as bandwidth or communications can respond to ID preferences such as those that may restrict access, provide priority, limit the times of use, etc.

Confirmation [symbol] method whereby learned behavior and other specific operating routines are presented for review and/or approval by user or manager

Non-ID Preferences [symbol] Operating Responses that are implemented when an occupant is detected but cannot be identified by the system and can include responses such as sending an alarm notification to a remote monitoring service, lock-down of physical access controls, restricted access to data, and other security measures.

Detection [symbol] detection that a person, vehicle or other occupant is approaching or has entered the area managed by the system

Occupant [symbol] any person, vehicle or entity detected by the system in the area managed by the system

User [symbol] an occupant detected by the system

Challenge [symbol] when an occupant that is not already identified by the system is detected, a challenge is issued requesting an ID [symbol] can be issued by a local or remote communicating CPU

Trigger Response—a response that is triggered by an algorithm in the Decision Engine based on the conditions observed by sensors and communicating devices, preferences and identification (or lack thereof) of a user or occupant.

Privacy gate: a software algorithm that confines the occupant detection information to one or more specific CPUs (so that, for example, the data is provided to a local CPU but not to any CPU located outside the user's direct location). Privacy gates can also limit the time that information is retained for specific users, the types of information retained, and those who are authorized to access the data. In addition, a privacy gate can be set to use a generic “avatar” to represent a user, such as a “guest”, so that their specific information or identity is not recorded even if it is able to be detected, and a set of preferences is implemented that relate to the avatar representing that user.

Managed functions of a resource—can include the generation, delivery, transformation, storage or consumption of a given resource.

### DETAILED DESCRIPTION

With reference to the block diagram of Figure A-1, one embodiment of the resource management system 100 of the present invention is now described in detail. The main components of the resource management system 100 are a central processing unit and Decision Engine 110, one or more presence detection devices 108, and one or more resource devices 114 (which can be controls and sensors as further described). The Decision Engine 110 interoperates with various databases including user profile database 112, automation rules database 118, resource database 116, and historical database 122. Also shown in Figure A-1 is a user identification (ID) token 104 that is carried by a user 102, as well as a user interface device 106 that can be operated by the user 102 as will be described. A set of external systems and devices 120 are also shown in communication with the Decision Engine 110. A privacy gate 126 communicates with a cloud-based CPU 124 via the cloud 122 as shown, which will also be further described herein.

A user ID token 104 can be any token or device carried by or otherwise associated with the location of a user that will serve to identify the user to the resource management system 100, as well as enable one or more presence detectors 108 to determine the presence and/or location of that user 102. For example, a user ID token 104 can be a near field communications (NFC) device such as those being put into use in smartphones such as the BLACKBERRY BOLD 9900. In this case, the presence detector(s) are capable of detecting the presence of the NFC device carried by the user 102 as that user 102 enters the proximity of the presence detector 108. This can occur if an NFC detector is located at the entry door of the user's premises such that the user's arrival home (or departure from home as will be described further below) is detected when the user is within proximity of the NFC detector as established by the operational characteristics of that device. In another embodiment, the user ID token 104 can be a bluetooth-enabled smartphone and the presence detector can be a bluetooth-enabled device located in a given area of the user's premises (for example a meeting room) that can detect when the user is in or approaching that area. In another example, the user ID token can be a GPS-enabled cell phone and the presence detector 108 can be a GPS system that can detect when the user is driving on the street near the user's premises. This methodology is also known as geofencing and is well known in the art. Other methodologies and technologies that enable detection of the presence of a user within a given area can be used by the present invention.

Referring also now to the flowchart of Figure A-2, the user enters the detection region 202, which would be defined by the technical capabilities and operating parameters of the particular presence detection device 108 being implemented in the system 100. The user presence is detected at step 204, and the user is attempted to be identified at step 206 by the central processing unit and Decision Engine 110. This can be as simple as performing a lookup of the user profile database 112 to determine if there is a profile record stored for that user 102 as indicated by his or her user ID as extracted from the token 104. For example, if the token 104 is an NFC device, then that device will send out a unique identification number that is used to query the user profile database 112 for confirmation of the user 102. If a user profile is found, then that profile is returned to the Decision Engine 110 for further processing.

In the event that detection of the user ID token does not result in retrieval of a user profile (step 205), then an optional identification process can be utilized if warranted by the system. For example, a challenge can be issued to the user by the presence detector 108 (or by an associated device).

This can be for example a query such as “provide your name and password” or the like, which can be displayed on an interactive display, emitted from an audio speaker, etc. The user can be able to enter a response at step 207 into the system based on the input device provided, such as a keyboard, microphone, etc.

The central processing unit and Decision Engine 110 can utilize the response from the user to further query the profile database 112 (or other internal or external security mechanisms) to ascertain if the user 102 is an authorized user and how to proceed at that point. For example, if the user cannot provide authorization, he can be denied entry into the premises if the presence detector is a doorway sensor and the desired function is opening of a lock on the door. In a situation where security is less of a factor, such as if the desired function is to modify the heating controls of a room being entered by the user, the system 100 can then just simply maintain the status quo if an unrecognized user enters the room.

Assuming that the user has been adequately identified and the appropriate user profile is accessed by the Decision Engine 110 at step 208 from the user profile database 112, then the Decision Engine will access resource data at step 210 by reference to the resource database 116. The resource database 116 can include various types of environmental data, such as room temperature, the humidity level of the air in the room being entered, the light setting for the room, and the like. Virtually any measurable parameters regarding the surroundings of the premises associated with the presence detectors 108 can be stored in the resource database 116.

At step 212, an analysis is undertaken of the resource data from database 116 and the user profile data from the database 112. The adaptive automation rules database 118 can also be referred to in this process. For example, the user 102 can be entering a room in which the temperature is measured at 68 degrees, which is stored in the resource database 116. The user profile 112 for the user 102 can indicate a preference for a temperature setting of 72 degrees. In this simple scenario, the Decision Engine 110 would then generate a command at step 214 that is sent to a resource control 114 such as a thermostat that increases the setting at step 216 to provide more heat in the room, until it reaches a temperature of 72 degrees. This scenario can be modified, however, by a rule from database 118 that only allows the temperature to increase to a predefined maximum of 70 degrees. This would override the preference of the user, for example, if the cost of heating fuel such as oil is above a certain limit or based on such other factors, for example, as the time of day or day of the week.

At step 218 the resource sensor outputs (in this case, thermostat room temperature readings) are provided back to the database 116 and analyzed by the Decision Engine 110 in an iterative loop until the desired condition is reached, as determined by the preferences established in the user profile 112 as well as the automation rules 118 as described above.

In addition, external devices and systems 120 that are outside the resource management system 100 can be controlled by the present invention. For example, the user profile 112 of the user 102 can indicate that he likes to listen to classical music. A command can be generated by the Decision Engine 110 that turns on a music system in the room being entered and sets the musical genre to classical.

In a more complex embodiment, a second user can enter the premises and that second user can have their profile 112 accessed and analyzed as explained above. Priorities can be established in the system and stored in the automation rules database 118 and/or the user profile database 112, which would indicate a level of priority to each user and/or situation. For example, the second user can have priority over the first user with respect to temperature control, such that if the second user has a cooler preference in his or her profile (e.g. 69 degrees) then room temperature will be modified accordingly, notwithstanding the first user's preference for a 72 degree environment. Similarly, if the first user has a higher priority for musical selection, then his preference for classical music will be followed even if the second user enters the room with a preference for jazz music.

In another embodiment, the Decision Engine can ascertain when a user enters an area, and when that person leaves that area. For example, if user 102 triggers a first presence detector 108 outside of an entry to an area and then triggers a second presence detector 108 on the other side of the entry into that area, then the Decision Engine 110 may conclude that the user 102 has entered and is within that area. If afterwards the first presence detector 108 is again triggered, and then subsequently another detector 108 in another part of the premises is triggered and the second presence detector 108 has not been triggered, then the Decision Engine 110 may conclude that the user 102 has left and is outside of the area. This intelligence allows the Decision Engine to keep track of how many users can be within a given area at any given time, as well who in particular is in that area.

This enables further intelligent control of the environment in that area. For example, the Decision Engine 110 may follow a rule from database 118 that provides for an increase in airflow if the number of people exceeds a certain number, or it could raise the level of ambient music if the number of people exceeds a certain number, etc. Likewise, a priority scheme can be followed so that preferences of a certain user are followed when that user enters the area, which would take priority over other users determined to be in that area.

Conflicts are resolved by an interpolation algorithm in the Decision Engine.

### Display Protocol:

In order to provide a clear and intuitive display whose significance is easily understood by a typical user, a graphical display format is delivered in which the a particular resource (for example electricity) is analyzed so that the data displayed on one axis of the graph (for example the y-axis) relates to particular parameters associated with that resource (such as, in the example of electricity, the quantity used over a specific interval, the total cost, the cost during each interval, the demand, temperature (internal, external, setpoint, etc.) and other parameters derived from data collected by devices and sensors in the system. The other axis (in this example the x-axis) represents changing intervals (such as time periods, cost, or other measurements) that index the changes in the resource parameters denoted on the other axis (e.g. the y-axis). Multiple parameters can be combined into a single display, in order to demonstrate their interrelationship. The convention in the display that is used to present the data to the user in a way that corresponds to their direct experience is that total overall consumption or usage of a resource (which can be either the actual measured consumption or the projected consumption based on historical data projected onto actual conditions) is displayed as a negative entry (that is, if the intersection of the x-axis on the y-axis represents zero, then consumption would be displayed “below the line”, i.e. below the x-axis) since that consumption represents a cost to the user (that is a negative impact). Conversely those operations of the system that result in a positive outcome to the user, in this example a reduction in consumption, are represented as positive entries (that is above the line of the x-axis). Examples include the display of total actual generation of a resource as positive (above the x axis) vs. actual consumption of the resource as negative (below the x-axis), and the net total of the two as either positive or negative depending on the total outcome and displayed accordingly. Similarly, another display of a projected analysis might display generation plus conservation of a resource (both positive and above the x-axis in this example) since they both contribute to the reduction of consumption) vs. projected consumption as the negative parameter displayed below the x-axis), with the net total of the two then displayed accordingly. We use the term “consumption” display as a general term to refer to displays of various parameters related to consumption of a resource. The may include but are not limited to: measured consumption, projected consumption or actual vs. projected consumption, etc. Similarly, the term “generation” display is used as a general term to refer to displays of various parameters related to generation of a resource but also including other activities that can reduce or counterbalance consumption of that resource. Generation parameters can include but are not limited to: measured generation, projected generation or actual vs. projected generation. The consumption and generation displays can include subsets of information displayed for specific devices. The net amount representing the total of consumption (negative) plus generation and conservation (positive) is represented as either positive (above the x-axis) if the amount of generation (including conservation) of a resource exceeds consumption, or negative if the reverse is true. Thus the user has a clear and intuitive graphical view that uniquely displays the derivation and comparison of specific parameters related to resource usage, resource generation (and conservation), and the net result and impact, and how these change over specific intervals over a period of time with respect to the displayed parameters and their interactions, which can further include local and environmental conditions that also affect consumption and generation, such as temperature, humidity, ambient light, congestion, resource availability, visibility, etc.—any parameter that is can be important to the system or the user in determining specific responses, whether automated or manually implemented.

The system can be used to create a time-lapse animation of the operation of a facility, showing the changing location, movements and identities of occupants, over an historical time period, in real time, or in a predictive mode.

What is claimed is:

1. A system to automate the control and management of other systems in an area, in response to the presence, identification, characteristics, preferences and priorities of one or more occupants in an area of a facility, comprising:
a. One or more sensor arrays each containing one or more sensors used to detect physical parameters of an occupant, such as location, direction of movement, speed, size, etc.,
b. a communications method to communicate the sensor data to a computer, and
c. a communications device to query the detected occupant for its identification code
d. a computer algorithm operating with a first database of identified users that links the identification code response to the query (or lack thereof) to a defined occupant or class of occupants, and then matching the occupant(s) to a table of instructions for system responses stored in a database. These responses may vary according to an occupant's priority level and preferences in various areas of the facility for environmental and operating conditions such as temperature, lighting and other conditions that can result in the consumption of resources;
e. a second database that stores past and present data about the activities of previous occupants collected by the sensors,
f. a third database that stores present and previous information about resource provider preferences, resource market conditions, resource supply source conditions, environmental conditions and resource system impact on the environment
g. a computer algorithm in that operates on present data and historical data in the second database to calculate the probabilities that the present occupant will take various courses of action
h. a computer algorithm that controls the type and degree of response by analyzing and correlating the data in the second and third databases and applying a set of instructions stored in the first database. These instructions determine the type and degree of system response. The manager establishes a set of goals for the system and limits on the operating conditions. The algorithm applies these in managing the system to meet these goals.

2. A computer algorithm that takes the preferences and priorities of identified occupants from a first database along with data about the relationship between system performance and the consumption of a given resource from a second database. The algorithm applies a set of rules established to meet a performance goal set by the manager for operation of the system with respect to consumption of a resource at a facility, for example, where the performance goal is to minimize the use of electricity.
a. A user-interface display that shows the performance of the system using a multiple bar graph format to display the amount of a resource consumed as a negative entry (below the line), the amount of a resource generated locally as a positive entry (above the line) and a third entry being the net sum of the two—either positive if more of the resource is being generated locally than is consumed, or negative if the reverse is true. A zero entry on the display would indicate that local generation is equal to consumption.
